(19) United States
(12) Patent Application Publication
(10) Pub. No.: US 2007/0234350 A1
(43) Pub. Date: Oct. 4, 2007

(54) METHOD AND COMPUTER SYSTEM CAPABLE OF INSTALLING A DRIVER WITHOUT DYNAMICALLY ALLOCATING STORAGE SPACE FOR THE DRIVER

(76) Inventors: Jiangbo Wang, Taipei Hsien (TW); Bingbing Cao, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/466,108

(22) Filed: Aug. 22, 2006

(30) Foreign Application Priority Data
Feb. 24, 2006 (TW) 095106414

(51) Int. Cl. G06F 9/445

(52) U.S. Cl. 717/174

(57) ABSTRACT

A method and a computer system for installing a driver are disclosed. The method includes: storing a system kernel, a driver and address data into a first storage unit, wherein the address data defines that the driver is predetermined to be stored in a predetermined storage space of a second storage unit; storing the system kernel stored in the first storage unit into the system kernel storage space; and executing the system kernel to read the driver from the predetermined storage space according to the address data for installing the driver.

### BACKGROUND OF THE INVENTION

1. Field of the Invention

The invention relates to a method and a system for installing computer software, and more particularly, to a method and a system for quickly installing a driver without dynamically allocating a storage space for the driver.

2. Description of the Prior Art

In general, when a computer system is booting, the computer system executes a booting procedure and then executes an operating system (OS). Furthermore, the computer system often executes a system kernel to control the above-mentioned booting procedure. As is well known, the system kernel installs multiple needed drivers, such as an integrated drive electronics (IDE) driver.

In the prior art, the process by which the target computer executes the system kernel and installs a plurality of drivers can be divided into two parts. The first part utilizes a develop-use computer, inside which an OS and developing tool software (such as windows visual studio 6.0) have been installed, for developing the system kernel and the driver. Then, the develop-use computer combines the system kernel and the driver into an integrated file and stores the integrated program file into the target computer. The second part utilizes the above-mentioned integrated program file to install the driver.

Please refer to FIG. 1, which is a block diagram of a conventional target computer 10. The target computer 10 comprises storage units 12 and 14, and a central processing unit (CPU) 16. Please note that the develop-use computer DC stores the integrated file IF having the system kernel SK and drivers Da and Db into the storage unit 12. In addition, the storage unit 14 is utilized to temporarily store the program codes and data for the target computer 10 process.

First of all, the CPU 16 executes the system kernel SK. After the CPU 16 discovers and initializes the storage unit 14, the CPU 16 copies the system kernel SK stored inside the storage unit 12 to a storage space S_SK of the storage unit 14. The CPU 16 then reads the system kernel SK from the storage space S_SK to execute it. When the system kernel SK, which is being executed, needs to install the driver Da, the system kernel first finds the driver Da in the storage unit 12 and analyzes the file header FHa of the driver Da to obtain related parameters. A storage space Sa of the storage unit 14 is then dynamically allocated. Assuming that the starting address of the storage space Sa is SAa, the system kernel SK writes the driver Da into the storage space Sa according to the starting address SAa, and adjusts the corresponding positions of the driver Da inside the storage space Sa according to the starting address SAa and related parameters of the file header FHa. For example, the related data can be adjusted according to .reloc Section. Then, the CPU 16 executes the initializing operations of the driver Da from the entry point EPa of the driver Da. Finally, the CPU 16 executes the system kernel SK (please note that, at this time, the installation of the driver Da is completed).

Similarly, if the system kernel SK needs to install the driver Db, the system kernel SK first finds the driver Db in the storage unit 12 and analyzes the file header FHb of the driver Db to obtain related parameters. A storage space Sb of the storage unit 14 is dynamically allocated according to the size of the driver Sb. Assuming that the starting address of the storage space Sb is SAb, the system kernel SK writes the driver Db into the storage space Sb according to the starting address SAb, and adjusts the corresponding positions of the driver Db inside the storage space Sb according to the starting address SAb and related parameters of the file header FHb. The CPU 16 then executes the initializing operations of the driver Db from the entry point EPb of the driver Db. The CPU 16 executes the system kernel SK (please note that, at this time, the installation of the driver Db is completed). Finally, the target computer 10 completes the installation of the drivers Da and Db.

If other drivers need to be installed/loaded, the above-mentioned procedures are repeatedly performed. As mentioned previously, when the system kernel SK dynamically installs/loads the driver Da, the system kernel first needs to read and check the related information of the driver Da, then the system kernel SK dynamically drives the storage unit 14 to allocate appropriate storage space Sa for the driver Da. When performed in this way, the initialization procedure is complex and time-consuming, resulting in the conventional computer 10 having a bad performance.

### SUMMARY OF THE INVENTION

A method and a system for quickly installing a driver without dynamically allocating a storage space for the driver are provided.

According to an exemplary embodiment, a method for installing a driver is disclosed. The method comprises: storing a system kernel, a driver, and address data in a first storage unit, wherein the address data defines that the driver is predetermined to be stored in a predetermined storage space of a second storage unit; storing the system kernel stored in the first storage unit into a system kernel storage space inside the second storage unit, and storing the driver stored in the first storage space into the predetermined storage space; and executing the system kernel to read the driver from the predetermined storage space according to the address data for installing the driver.

According to another exemplary embodiment, a computer system is disclosed. The computer system comprises: a first storage unit, storing a system kernel, a driver, and address data; a second storage unit; and a controller, coupled to the first storage unit and the second storage unit, for storing the system kernel stored inside the first storage unit to a system kernel storage space of the second storage unit, storing the driver stored inside the first storage unit to a predetermined storage space of the second storage unit, and for executing the system kernel to read the driver from the predetermined space according to the address data for installing the driver; wherein the address data defines that the driver is predetermined to be stored in the predetermined storage space of the second storage unit.

According to another exemplary embodiment of the claimed invention, a computer system for generating system software is disclosed. The computer system comprises: a first logic unit, for determining address data according to a driver stored in a predetermined space of a storage unit of a target computer, the address data being utilized to help the target computer install the driver; and a second logic unit, for generating the system kernel according to a system kernel, the driver, and the address data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a conventional target computer.

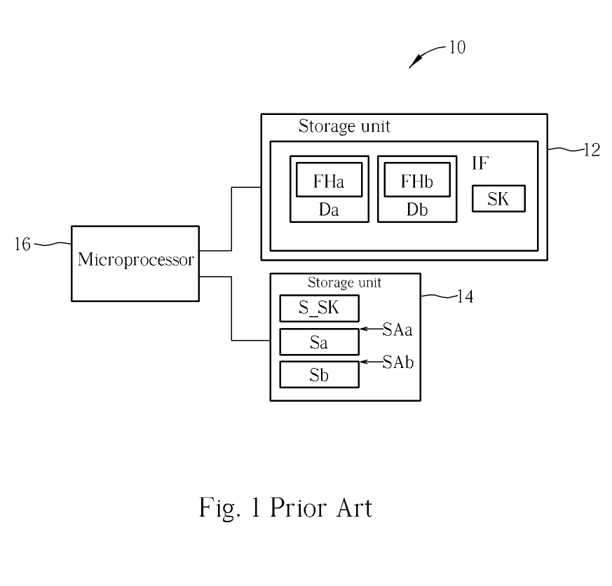

FIG. 2 is a functional block diagram of an embodiment of the target computer according to the present invention.

FIG. 3 is a diagram of the allocation of storage space of the storage unit of a first embodiment according to the present invention.

FIG. 4 is a functional block diagram of an embodiment of a develop-use computer according to the present invention.

FIG. 5 is a flow chart illustrating the develop-use computer shown in FIG. 4 generating the integrated program file IFP.

FIG. 6 is a flow chart illustrating how the target computer shown in FIG. 2 utilizes the integrated program file IPF having the descriptor table DT to execute the extensible firmware interface EFI and install the drivers D1 and D2.

FIG. 7 is a diagram of the allocation of storage space of the storage unit shown in FIG. 2 of a first embodiment according to the present invention.

### DETAILED DESCRIPTION

In an embodiment of the present invention, a target computer 30 needs to execute an extensible firmware interface (EFI) and install a plurality of drivers D1 and D2. The present invention can be divided into two steps. In the first step, the present invention utilizes a develop-use computer 20, inside which an OS and developing tool software (such as windows visual studio 6.0) are installed, for generating system software having a descriptor table. In this embodiment, the system software is an integrated program file IPF, which comprises an extensible firmware interface (EFI) and the drivers D1 and D2. The address data stored inside the descriptor table defines the address data of the storage space in the target computer 30, which is predetermined to store the drivers D1 and D2. The develop-use computer 20 stores the integrated program file IPF inside the target computer 30. In the second step, the target computer 30 utilizes the integrated program file IPF having the above-mentioned address data to execute the extensible firmware interface EFI and install the drivers D1 and D2. At this time, the target computer 30 does not need to dynamically check the sizes of the drivers D1 and D2 before installing the drivers D1 and D2. As is well known, after executing the extensible firmware interface EFI, the target computer 30 then installs a plurality of needed drivers D1 and D2. For example, the driver D1 is an integrated drive electronics (IDE) driver. Please note that, in the following disclosure, the structures of the develop-use computer 20 and the target computer 30 will be respectively illustrated and then the processes of the above-mentioned first step and second step will be illustrated.

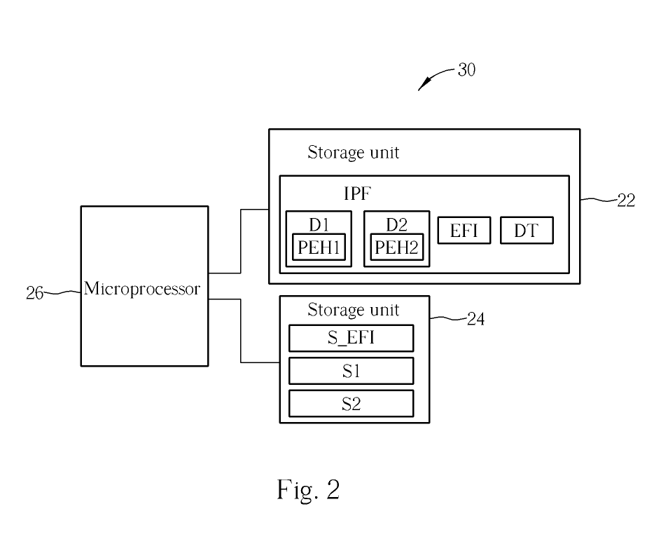

Please refer to FIG. 2, which is a functional block diagram of an embodiment of the target computer 30 according to the present invention. As shown in FIG. 2, the target computer 30 comprises a plurality of storage units 22 and 24 (such as memories) and a microprocessor 26 (such as a CPU). In this embodiment, the storage unit 22 is a non-volatile memory, such as a read-only memory (ROM). Please note that the integrated program file IPF stored inside the storage unit 22 is illustrated as above. First, the develop-use computer 20 generates the integrated program file IPF and then stores it inside the storage unit 22. The process of generating the integrated program file IPF will be illustrated in the following disclosure.

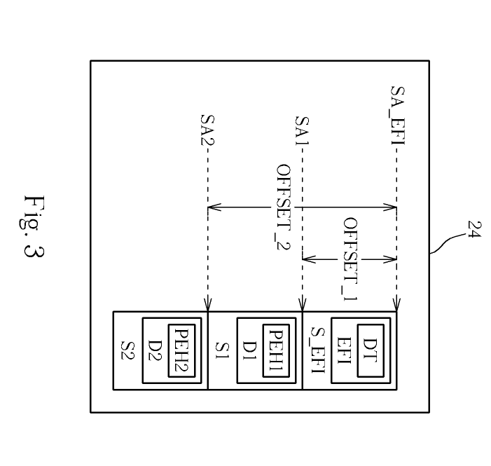

The integrated program file IPF comprises a system kernel, a plurality of drivers D1 and D2, and a descriptor table DT. The drivers D1 and D2 respectively comprise file headers PEH1 and PEH2. The file headers PEH1 and PEH2 respectively have the information of entry points EP1 and FP2 of the drivers D1 and D2. The descriptor table DT will be illustrated later. Please note, only two drivers D1 and D2 are shown in FIG. 2, but the present invention does not limit the number of drivers. In addition, although in this embodiment, the system kernel is the above-mentioned extensible firmware interface EFI, the system kernel is not limited as the extensible firmware interface EFI. In the actual implementation, the system kernel can be any program codes for controlling the installation of the drivers. For example, the present invention mechanism of previously loading the drivers to the storage unit can be applied to an operation system to install needed drivers. This also obeys the spirit of the present invention. In this embodiment, the storage unit 24 is a volatile memory, for example, the storage unit 24 is a dynamic random access memory. Please refer to FIG. 3, which is a diagram of the allocation of storage space of the storage unit 24 of a first embodiment according to the present invention. In the first embodiment, the storage space S1 is adjacent to the storage space S_EFI, and the storage space S2 is adjacent to the storage space S1. The storage spaces S_EFI, S1, and S2 are predetermined to temporarily store the extensible firmware interface EFI, the driver D1, and the driver D2 respectively in the booting procedure. This process will also be illustrated later. The microprocessor 26 is coupled to the storage units 22 and 24 for controlling the operation of the target computer 30.

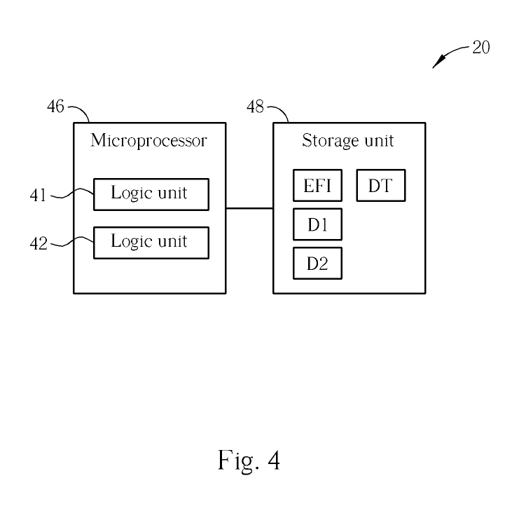

Please refer to FIG. 4, which is a functional block diagram of an embodiment of a develop-use computer 20 according to the present invention. The develop-use computer 20 comprises a microprocessor 46 and a storage unit 48. The microprocessor 46 comprises a plurality of logic units 41 and 42, each of which is composed of a plurality of logic gates for executing a logic operation to implement the function of the microprocessor 46. The logic operations performed by the logic units 41 and 42 will be illustrated later. The storage unit 48 is coupled to the microprocessor 46 for storing data. For example, the storage unit 48 can be utilized to store the extensible firmware interface EFI and the drivers D1 and D2, which are to be integrated as the integrated program file IPF.

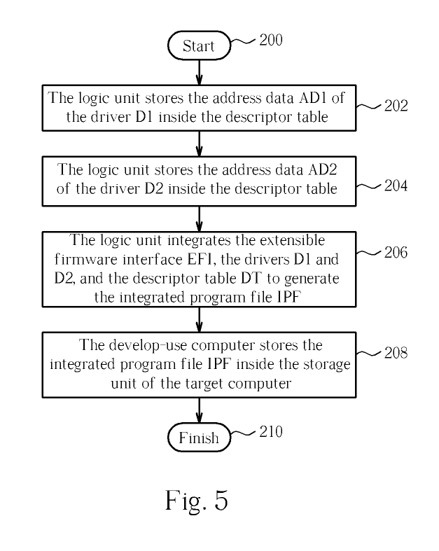

Please note that the detailed process of the above-mentioned first step will be illustrated as follows. Please refer to FIG. 2, FIG. 3, FIG. 4, and FIG. 5. FIG. 5 is a flow chart illustrating the develop-use computer 20 shown in FIG. 4 generating the integrated program file IFP. The flow chart comprises the following steps:

Step 200: Start;

Step 202: The logic unit 41 stores the address data AD1 of the driver D1 inside the descriptor table;

Step 204: The logic unit 41 stores the address data AD2 of the driver D2 inside the descriptor table;

Step 206: The logic unit 42 integrates the extensible firmware interface EFI, the drivers D1 and D2, and the descriptor table DT to generate the integrated program file IPF;

Step 208: The develop-use computer 20 stores the integrated program file IPF inside the storage unit 22 of the target computer; and

Step 210: Finish.

In this embodiment, after the flow is started (step 200), the logic unit 41 of the microprocessor 46 knows that the driver D1 (which is stored inside the storage unit 48) should be stored into the storage space S1 in the storage unit 24 of the target computer 30. The logic unit 41 adjusts the corresponding positions of the driver D1 (for example, the logic unit 41 can adjust the entry point EP2 of the driver D2) according to related parameters inside the file header PEH1 of the driver D1 and the starting address SA1 of the storage space S1. Because the above operations are well known, any further illustration is omitted here. The logic unit 41 then stores the address data AD1 of the driver D1 inside the descriptor table DT. The address data AD1 comprises the file name, the starting address SA1 or an offset OFFSET_1, and the entry point EP1 of the driver D1 (step 202). At this point, the logic unit 41 knows that the driver D2 (which is originally stored inside the storage unit 48) should be stored into the storage space S2 inside the storage unit 24 of the target computer 30. The logic unit 41 adjusts the corresponding positions of the driver D2 (for example, the logic unit 41 can adjust the parameters of the file header PEH2, such as the entry point EP2 of the driver D2) according to related parameters inside the file header PEH2 of the driver D2 and the starting address SA2 of the storage space S2. Then, the logic unit 41 stores the address data AD2 of the driver D2 inside the descriptor table DT. The address data AD2 comprises the file name, the starting address SA2 or an offset OFFSET_2, and the entry point EP2 of the driver D2 (step 204). Please note that the above-mentioned offsets OFFSET_1 and OFFSET_2 can be defined by a programmer. The address that the starting address SA_EFI of the storage space S_EFI adds the offset OFFSET_1 to is the starting address SA1 of the storage space S1 for storing the driver D1. The address that the starting address SA_EFI of the storage space S_EFI adds the offset OFFSET_2 to is the starting address SA2 of the storage space S2 for storing the driver D2.

In addition, in this embodiment, the descriptor table DT is predetermined to be stored inside the storage space S_EFI, and located in front of the extensible firmware interface EFI (for example, the descriptor table DT is stored in the file header of the extensible firmware interface EFI). Therefore, the predetermined storage address of the descriptor table DT inside the storage unit 24 is the predetermined storage address of the extensible firmware interface EFI in the storage unit 24 (the starting address SA_EFI of the storage space S_EFI). In other embodiments, however, the descriptor table DT can also be stored in another storage space that the microprocessor 26 is able to access.

The logic unit 42 then integrates the extensible firmware interface EFI, the drivers D1 and D2, and the descriptor table DT to generate the integrated program file IPF, and first stores the integrated program file IPF inside the storage unit 48 (step 206). Finally, the develop-use computer 20 stores the integrated program file IPF inside the storage unit 22 of the target computer 30 (step 208). At this point the entire flow is finished (step 210). In this embodiment, the file headers PEH1 and PEH2 of the above-mentioned drivers D1 and D2 are both portable executable file header (PE headers). In other words, the file headers PEH1 and PEH2 both comply with Microsoft Portable Executable and Common Object File Format Specification. In addition, in other embodiments of the present invention, the address data AD1 of the driver D1 does not store the entry point EP1 because the file header PEH1 of the driver D1 can store the entry point EP1. That is, for the address data AD1, the entry point EP1 is optional information. Similarly, for the address data AD2, the entry point EP2 is optional.

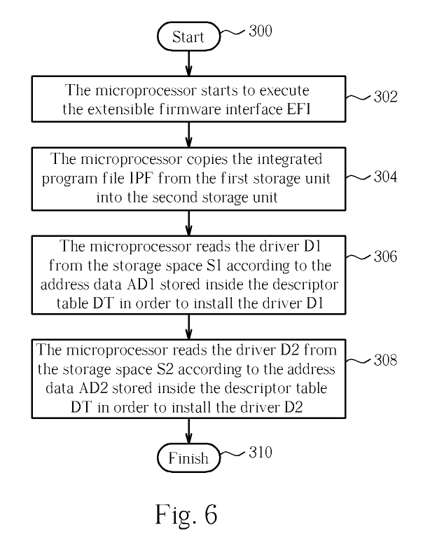

The detailed process of the aforementioned second step will now be illustrated. Please refer to FIG. 3 in conjunction with FIG. 6. FIG. 6 is a flow chart illustrating how the target computer 30 shown in FIG. 2 utilizes the integrated program file IPF having the descriptor table DT to execute the extensible firmware interface EFI and install the drivers D1 and D2. It comprises the following steps:

Step 300: Start;

Step 302: The microprocessor 26 starts to execute the extensible firmware interface EFI;

Step 304: The microprocessor 26 copies the integrated program file IPF from the storage unit 22 into the storage unit 24;

Step 306: The microprocessor 26 reads the driver D1 from the storage space S1 according to the address data AD1 stored inside the descriptor table DT in order to install the driver D1;

Step 308: The microprocessor 26 reads the driver D2 from the storage space S2 according to the address data AD2 stored inside the descriptor table DT in order to install the driver D2; and

Step 310: Finish.

After the target computer 30 is booted (step 300), the microprocessor 26 starts to execute the extensible firmware interface EFI (step 302). After the microprocessor 26 discovers and initializes the storage unit 24, the microprocessor 26 copies the integrated program file IPF from the storage unit 22 to the storage unit 24. That is, the microprocessor 26 utilizes a memory controller (not shown) to control the storage unit 24 to allocate the storage spaces S_EFI, S1, and S2 for storing the extensible firmware interface EFI and the drivers D1 and D2 of the integrated program file IPF (step 304). The microprocessor 26 then executes the integrated program file IPF. First, the extensible firmware interface EFI is executed. When the extensible firmware interface EFI wants to install the driver D1, the extensible firmware interface EFI finds the address data AD1 (including the file name, the starting address SA1 or an offset OFFSET_1, and entry point EP1) of the driver D1 from the descriptor table DT. The microprocessor 26 then finds the driver D1 according to the starting address SA1 and jumps to the entry point EP1 (which is stored in the descriptor table DT or the file header PEH1) of the driver D1 to execute the initialization operation of the driver D1. Then, the microprocessor 26 executes the extensible firmware interface EFI (at this time, the installation of the driver D1 is completed) (step 306). When the extensible firmware interface EFI wants to install the driver D2, the extensible firmware interface EFI finds the address data AD2 (including the file name, the starting address SA2 or an offset OFFSET_2, and entry point EP2) of the driver D2 from the descriptor table DT. The microprocessor 26 then finds the driver D2 according to the starting address SA2 and jumps to the entry point EP2 (which is stored in the descriptor table DT or the file header PEH2) of the driver D2 to execute the initialization operation of the driver D2. The microprocessor 26 then executes the extensible firmware interface EFI (at this time, the installation of the driver D2 is completed) (step 308). Finally, the target computer 30 successfully completes the installations of the drivers D1 and D2.

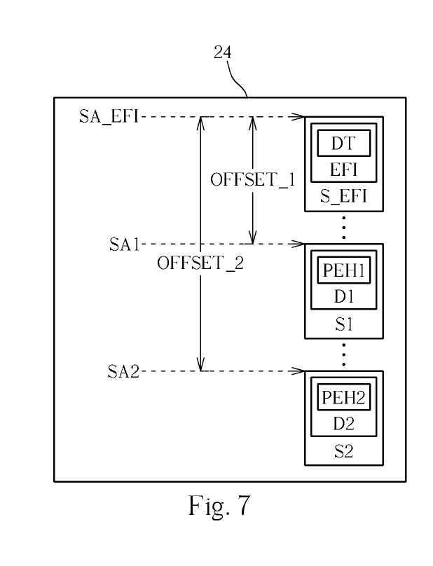

As mentioned previously, the size of the present invention storage spaces S1 and S2 are not determined by the prior art checking of the sizes of the drivers D1 and D2 executed by the microprocessor 26. In other words, before the second step, the starting addresses SA_EFI, SA1, and SA2 are predetermined instead of dynamically determined. In addition, an objective of the present invention is that the areas where the extensible firmware interface EFI and the drivers D1 and D2 are stored inside the storage unit 24 of the target computer 30 are predetermined. Therefore, the process of integrating the extensible firmware interface EFI and drivers D1 and D2 into an integrated program file IPF is only an embodiment, not a limitation of the present invention. Please refer to FIG. 7, which is a diagram of the allocation of storage space of the storage unit 24 shown in FIG. 2 of a first embodiment according to the present invention. As shown in FIG. 7, the storage spaces S_EFI, S1, and S2 are separated. That is, the extensible firmware interface EFI, and the drivers D1 and D2 are separately stored in non-adjacent storage spaces S_EFI, S1, and S2 instead of being integrated into an integrated program file IPF and then stored into the storage unit 24.

For the above-mentioned second embodiment, in the first step, after the develop-use computer 20 executes the steps 200˜204, the develop-use computer 20 stores the extensible firmware interface EFI, the drivers D1 and D2, and the descriptor table DT into the storage unit 22 of the target computer 30. In the second step, after the steps 300˜302 are executed, the target computer 30 respectively copies the integrated program file IPF, the descriptor table DT, and the drivers D1 and D2 into non-adjacent storage spaces S_EFI, S1, and S2, then executes the steps 306_310 to complete the second step. The develop-use computer 20 and the target computer 30 can be the same computer. That is, the computer first executes the first step (at this time, the computer is regarded as the develop-use computer 20), the computer is shut down, and then the computer can further execute the second step (at this time, the computer is regarded as the target computer 30).

In the first embodiment shown in FIG. 3, the microprocessor 26 only needs to execute the integrated program file IPF such that the microprocessor 26 can orderly execute the extensible firmware interface EFI and the installations of the drivers D1 and D2. In the first embodiment, the extensible firmware interface EFI and the drivers D1 and D2 are positioned adjacent to the integrated program file IPF, whereas in the second embodiment (shown in FIG. 7), the extensible EFI and the drivers D1 and D2 are separately distributed in the storage unit 24. Therefore, when the extensible firmware interface EFI and the drivers D1 and D2 are being executed, the first embodiment can reduces time needed for reading the drivers D1 and D2 from the storage unit 24 compared to the second embodiment. Furthermore, the left storage space of the storage unit 24 of the first embodiment is not divided into several storage spaces. From the above disclosure, it can be seen that the performance of the storage unit 24 of the first embodiment is better.

In contrast to the prior art, the present invention installation method and computer system can store the drivers into predetermined storage spaces of the storage unit of the computer system before a system kernel (e.g. an OS or an extensible firmware interface) starts to operate. The computer system can then quickly read and execute the drivers stored inside the storage unit to directly and quickly perform the installations of the drivers. In other words, the present invention does not need to dynamically store the drivers into the storage unit after the system kernel operates for the following reading and installing the drivers. Instead, the present invention previously loads the driver from a storage unit (e.g. a ROM) to another storage unit (for example, the DRAM) before the system kernel operates. This can simplify the initialization of the computer system, efficiently reduce the complexities of the installation procedure, and eliminate the time for dynamically allocating storage spaces of the drivers.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for installing a driver, the method comprising:
(a) storing a system kernel, a driver, and address data in a first storage unit, wherein the address data defines that the driver is predetermined to be stored in a predetermined storage space of a second storage unit;
(b) storing the system kernel stored in the first storage unit into a system kernel storage space inside the second storage unit, and storing the driver stored in the first storage space into the predetermined storage space; and
(c) executing the system kernel to read the driver from the predetermined storage space according to the address data for installing the driver.

2. The method of claim 1, wherein the predetermined storage space is adjacent to the system kernel storage space.

3. The method of claim 1, wherein step (b) further comprises:
writing the address data stored inside the first storage unit into the second storage unit; and
the step (c) further comprises:
installing the driver according to the address data stored inside the second storage unit.

4. The method of claim 1, wherein the address data is a starting address stored in the predetermined storage space by the driver.

5. The method of claim 1, wherein the system kernel is an extensible firmware interface (EFI).

6. The method of claim 1, wherein the first storage unit is a read-only memory (ROM), and the second storage unit is a dynamic random access memory (DRAM).

7. A computer system comprising:
a first storage unit, storing a system kernel, a driver, and address data;
a second storage unit; and
a controller, coupled to the first storage unit and the second storage unit, for storing the system kernel stored inside the first storage unit to a system kernel storage space of the second storage unit, storing the driver stored inside the first storage unit to a predetermined storage space of the second storage unit, and for executing the system kernel to read the driver from the predetermined space according to the address data for installing the driver;
wherein the address data defines that the driver is predetermined to be stored in the predetermined storage space of the second storage unit.

8. The computer system of claim 7, wherein the predetermined space is adjacent to the system kernel storage space.

9. The computer system of claim 7, wherein the controller further writes the address data stored inside the first storage unit in the second storage unit; and the controller installs the driver according to the address data stored inside the second storage unit.

10. The computer system of claim 7, wherein the address data comprises a starting address of the driver stored in the predetermined storage space.

11. The computer system of claim 7, wherein the system kernel is an extensible firmware interface (EFI).

12. The computer system of claim 7, wherein the first storage unit is a read-only memory (ROM), and the second storage unit is a dynamic random access memory (DRAM).

13. A computer system for generating system software, the computer system comprising:
a first logic unit, for determining address data according to a driver stored in a predetermined space of a storage unit of a target computer, the address data being utilized to help the target computer install the driver; and
a second logic unit, for generating the system kernel according to a system kernel, the driver, and the address data.

14. The computer system of claim 13, wherein the second logic unit integrates the system kernel, the driver, and the address data as the system software.

15. The computer system of claim 13, wherein the storage unit is a dynamic random access memory (DRAM).
